(19) United States
(12) Patent Application Publication
(10) Pub. No.: US 2024/0147115 A1
(43) Pub. Date: May 2, 2024

(54) OPEN-EAR BLUETOOTH EARPHONE

(71) Applicant: UI (Wan An) Technology Co. Ltd, Ji'an (CN)

(72) Inventors: Zhaoquan MAI, Ji'an (CN); Xiaobin SHEN, Ji'an (CN); Yafan LI, Ji'an (CN); Jiaquan YI, Ji'an (CN); Yunfeng WANG, Ji'an (CN); Qian HE, Ji'an (CN); Hui HE, Ji'an (CN); Shaobing LAI, Ji'an (CN); Zhuoqi CHEN, Ji'an (CN); Yong WANG, Ji'an (CN); Jiabao CHEN, Ji'an (CN); Lei BAO, Ji'an (CN); Nan FENG, Ji'an (CN)

(73) Assignee: UI (Wan An) Technology Co. Ltd, Ji'an (CN)

(21) Appl. No.: 18/220,859

(22) Filed: Jul. 12, 2023

(30) Foreign Application Priority Data
Nov. 1, 2022 (CN) 202211354532.6

(51) Int. Cl. H04R 1/10

(52) U.S. Cl. CPC H04R 1/1016; H04R 1/1066; H04R 2420/07

(57) ABSTRACT

An open-ear Bluetooth® earphone includes an earphone body and a support frame. The support frame is configured to be plugged into a cavum concha of a wearer. The earphone body is provided with an audio source, and the support frame is installed on the earphone body and corresponds to the audio source. When in use, the support frame is configured to be firmly plugged into the cavum concha of the wearer to allow the earphone body to be worn on the ear of the wearer. The audio source corresponds to the ear canal of the wearer through the support frame, so that the sound emitted from the audio source is transmitted into the ear canal through the support frame. The audio source is directly opposite of the ear canal through the support frame to shorten the distance between the audio source and the ear canal.

### CROSS REFERENCE TO THE RELATED APPLICATIONS

This application is based upon and claims priority to Chinese Patent Application No. 202211354532.6, filed on Nov. 1, 2022, the entire contents of which are incorporated herein by reference.

### TECHNICAL FIELD

The present invention relates to the technical field of earphones, particularly an open-ear Bluetooth® earphone.

### BACKGROUND

Earphones are a pair of conversion units that accept electric signals from a media player or a receiver and convert them into an audible sound wave using a speaker close to the ears. Earphones include in-ear earphones. In-ear earphones provide a sense of pressure to the ear canal of the wearer, thus making the wearer's ears uncomfortable. In addition, in-ear earphones isolate the ear from the sound of the external environment, which is not conducive to the wearer's listening to the sound of the external environment when wearing the in-ear earphones. For this reason, semi-in-ear earphones are developed, and the semi-in-ear earphones reduce the pressure of the in-ear earphones on the ear canal. However, since the main body of the semi-in-ear earphones is made of hard plastic material, after the semi-in-ear earphones are worn for a long time, the hard plastic material plugged into the cavum concha will cause the wearer's ear to feel pain and other discomforts. Moreover, semi-in-ear earphones have poor stability that easily falls off when worn. Later, bone-conduction earphones are developed. Since the sound transmitted by the bone-conduction earphones is produced by the vibration of vibrators, sound quality suffers from a large transmission loss when the bone of the wearer receives the sound transmitted by vibration, which leads to poor sound quality received by the wearer wearing the bone-conduction earphones, and thus the wearer has a poor experience. Then, open-ear Bluetooth® earphones are developed.

The prior patent with a publication number of CN214429681U discloses a hanging and clamping ear-type open-ear earphone, which has the following advantages: A hanging and clamping ear-type structure is sleeved and hung on the upper side and the back side of the ear. An installation structure is connected to the upper end of the hanging and clamping ear-type structure and extends to the front side of the ear hole, and the sound outlet port faces the ear hole. In this way, there is no need to plug the earphones into the ear hole so the wearer can hear the sound of the surrounding environment, will not experience discomfort after wearing it for a long time, and will not cause damage to the hearing. However, since the size and outer contour of the wearer's ears vary from person to person, after different wearers wear the hanging and clamping ear-type open-ear earphones through the hanging and clamping ear-type structure, the sound outlet port of the installation structure may no longer face the ear hole, which makes it difficult for some wearers to receive the best sound, thus reducing the user experience of the wearers.

Moreover, as shown in the non-patent document (“JBL Nearbuds”, namely an open-ear Bluetooth® earphone: https://speaker.yesky.com/56/726008556.shtml), the open-ear Bluetooth® earphone is also hung on the ear by using the outer contour of the wearer's ears. Since the size and outer contour of the wearer's ears vary from person to person, when different wearers hang the open-ear Bluetooth® earphone on the ear through the outer contour of the ear, the distances between the audio source of the earphone and the ear canals of different wearers are different, so it cannot be adapted to different wearers. As a result, the sound emitted from the audio source of the earphone cannot be transmitted to the ear canal in the shortest distance, and the wearer's ears cannot receive the best sound, thus reducing the user experience of the wearer.

### SUMMARY

Given the above, an objective of the present invention is to provide an open-ear Bluetooth® earphone, which solves the problem that the audio source and the ear canal cannot be accurately located when the prior open-ear Bluetooth® earphone is worn and ensures that the audio source is tightly adheres to the ear canal and corresponds to the ear canal so that the sound emitted from the audio source is optimally transmitted into the ear canal to improve the user experience.

The objective of the present invention is realized through the technical solutions as follows:

An open-ear Bluetooth® earphone includes an earphone body and a support frame configured to be plugged into a cavum concha of a wearer. The earphone body is provided with an audio source, and the support frame is installed on the earphone body and corresponds to the audio source. When in use, the support frame is configured to be firmly plugged into the cavum concha of the wearer to allow the earphone body to be worn on the ear of the wearer. The audio source corresponds to the ear canal of the wearer through the support frame, so that the sound emitted from the audio source is transmitted into the ear canal through the support frame.

Further, an audio guide hole is formed in the support frame, and the audio guide hole of the support frame tightly adheres to the audio source. The audio guide hole is configured to transmit the sound emitted from the audio source into the ear canal.

Further, the earphone body includes a housing and an installation cavity arranged in the housing. The housing is provided with an installation hole, and the installation cavity is communicated with the outside through the installation hole. The audio source includes an audio board, and the audio board is installed inside the installation hole.

Further, the support frame tightly adheres to the housing, and the support frame surrounds the audio board through the audio guide hole.

Further, the housing is provided with a buckle, and the buckle is located outside the installation hole. The support frame is provided with a clamping slot cooperating with the buckle, and the support frame is connected to the buckle through the clamping slot.

Further, the opening of the clamping slot forms an extension part cooperating with the clamping slot. When the support frame is installed on the housing, the extension part wraps the buckle and abuts the housing.

Further, the audio source includes a speaker. The speaker is installed inside the installation cavity, and the speaker corresponds to the audio board. The sound emitted from the speaker is transmitted to the outside of the installation cavity through the audio board.

Further, the audio board is provided with a plurality of audio holes penetrating through the audio board.

Further, the support frame is made of soft and comfortable material.

In summary, the advantages of the present invention are as follows:

Compared with the prior art, the present invention provides an open-ear Bluetooth® earphone. When the support frame is plugged into the cavum concha of the ear, the audio source of the earphone body corresponds to the ear canal through the support frame and the audio source faces the ear canal, so that the audio source is directly opposite the ear canal through the support frame to shorten the distance between the audio source and the ear canal, and the sound emitted from the audio source is transmitted into the ear canal through the support frame, which is beneficial for the wearer to hear the best audio to improve the wearing experience of the wearer. The support frame is made of soft and comfortable material to reduce the squeeze of the support frame on the ear, which is conducive to improving the comfort of wearing. According to the different sizes of cavum conchae of different wearers, the support frame can be made in different sizes to adapt to different wearers. The present invention solves the problem that the distance between the audio source and the ear canal of the prior open-ear Bluetooth® earphone is large and the positions of the audio source and the ear canal cannot be accurately located. In this way, without being affected by the size of the ear of the wearer, the shape and size of the outer contour of the ear, and the like, the positions of the audio source and the ear canal are accurately located.

The present invention is described in detail in combination with the drawings for better understanding and implementation.

### BRIEF DESCRIPTION OF THE DRAWINGS

The drawings are only for exemplary illustration and shall not be construed as a limitation of the present invention. To better illustrate the embodiments, some parts in the drawings may be omitted, enlarged, or minimized, which do not represent the size of the actual product. For those skilled in the art, it is understandable that some of the known structures and descriptions in the drawings may be omitted.

FIG. 1 is a schematic diagram showing the structure of an ear model according to the present invention.

FIG. 2 is a schematic diagram showing the structure of a support frame plugged into the ear model according to the present invention.

FIG. 3 is a schematic diagram showing the structure of an open-ear Bluetooth® earphone worn by the ear model according to the present invention.

FIG. 4 is a schematic diagram showing the structure of the open-ear Bluetooth® earphone according to the present invention.

FIG. 5 is a schematic diagram showing the structure of the support frame according to the present invention.

FIG. 6 is a schematic diagram showing the structure of an earphone body according to the present invention.

FIG. 7 is a schematic diagram showing the structure of the open-ear Bluetooth® earphone worn by the ear model according to the present invention.

FIG. 8 is an A-A sectional view of FIG. 7.

In the figures, 1. earphone body; 11. housing; 11a. first housing; 11b. second housing; 111. installation hole; 112. installation cavity; 113. buckle; 12. audio source; 121. audio board; 122. speaker; 2. support frame; 21. audio guide hole; 22. clamping slot; 23. extension part; 3. ear; 31. cavum concha; and 32. ear canal.

### DETAILED DESCRIPTION OF THE EMBODIMENTS

The orientation terms, such as up, down, left, right, front, back, front side, back side, top, bottom, and others that are mentioned or may be mentioned in the specification, are defined relative to their construction, and all of them are relative concepts. They may change according to their different positions and use states. Therefore, these or other orientation expressions shall not be interpreted as restrictive terms.

The embodiments described in the following exemplary embodiments do not represent all embodiments consistent with the present disclosure. Instead, they are only examples of embodiments that are consistent with some aspects of the present disclosure.

The terms used in the present disclosure are solely for the purpose of describing specific embodiments and are not intended to limit the present disclosure. As used in the present disclosure, the singular forms of “a/an,” “said,” and “the” are also intended to include the plural form unless the context clearly states otherwise. It should also be understood that the term “and/or” used in the text refers to including any or all possible combinations of one or more associated listed items.

The present invention is further described in detail in combination with the drawings.

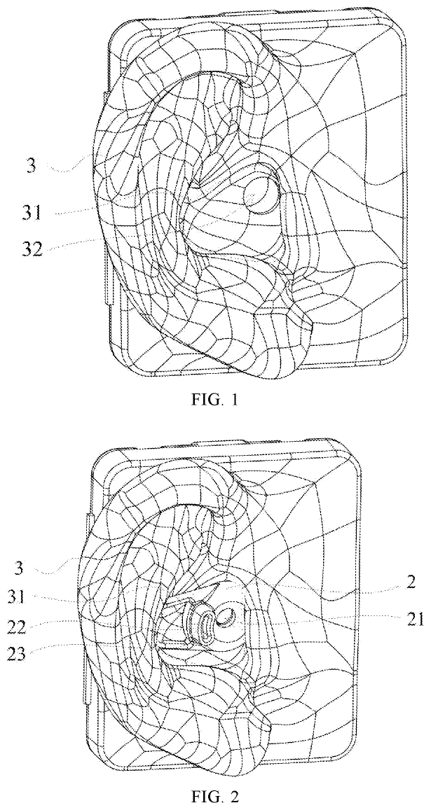

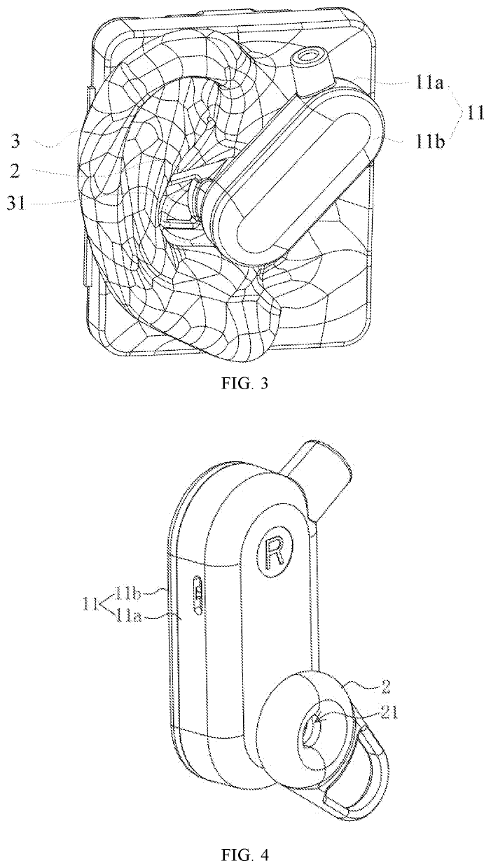

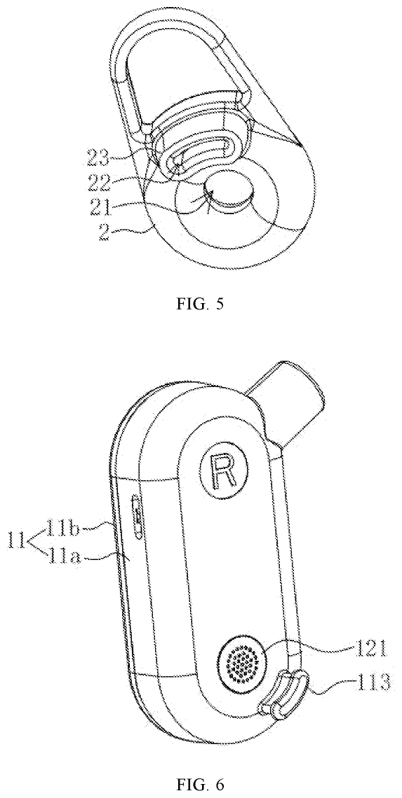

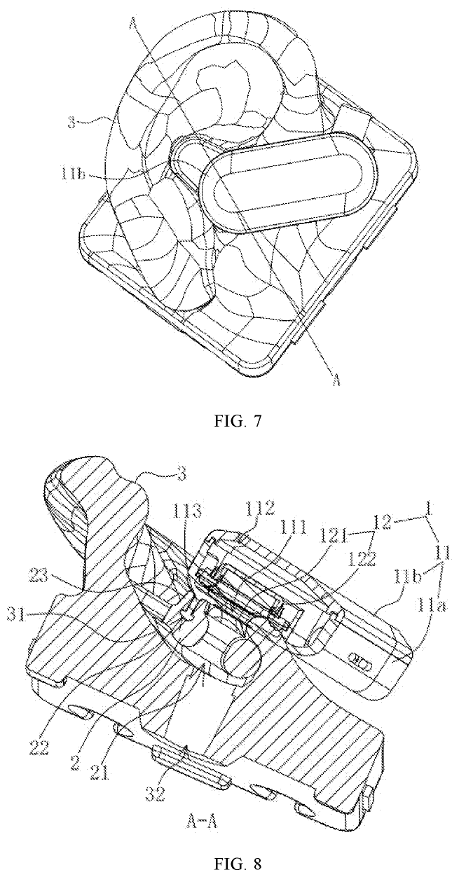

Referring to FIGS. 1-8, according to the present invention, an open-ear Bluetooth® earphone includes the earphone body 1 and the support frame 2. The earphone body 1 is provided with the audio source 12, and the support frame 2 is installed on the earphone body 1 and corresponds to the audio source 12. The support frame 2 is arranged to cooperate with the cavum concha 31 of the wearer's ear 3 so that the support frame 2 is easily plugged into the cavum concha 31. When in use, the earphone body 1 is worn on the ear 3 by the support frame 2. Specifically, the support frame 2 is firmly plugged into the cavum concha 31 of the wearer, so that the support frame 2 tightly adheres to the cavum concha 31. The audio source 12 corresponds to the ear canal 32 of the wearer through the support frame 2, and the audio source 12 faces the ear canal 32 so that the sound emitted from the audio source 12 is transmitted into the ear canal 32 through the support frame 2. Compared with the prior art, the support frame 2 is plugged into the cavum concha 31 of the ear 3 to realize that the audio source 12 of the earphone body 1 corresponds to the ear canal 32 and the audio source 12 faces the ear canal 32, so that the audio source 12 is directly opposite of the ear canal 32 through the support frame 2 to shorten the distance between the audio source 12 and the ear canal 32, and the sound emitted from the audio source 12 is transmitted into the ear canal 32 through the support frame 2, which is beneficial for the wearer to hear the best audio and improves the wearing experience of the wearer. According to the different sizes of the cavum conchae 31 of different wearers, the support frame 2 can be made in different sizes to adapt to different wearers. The present invention solves the problem that the distance between the audio source 12 and the ear canal 32 of the prior open-ear Bluetooth® earphone is large, and the positions of the audio source 12 and the ear canal 32 cannot be accurately located. In this way, without being affected by the size of the ear 3 of the wearer, the shape of the outer contour of the ear 3, the size of the outer contour of the ear 3 and the like, the positions of the audio source 12 and the ear canal 32 are accurately located.

In some embodiments, the audio guide hole 21 is formed in the support frame 2 and penetrates through the support frame 2. The audio guide hole 21 of the support frame 2 tightly adheres to the audio source 12. The audio guide hole 21 transmits the sound emitted from the audio source 12 into the ear canal 32, which is beneficial for the wearer to hear the best sound to improve the user experience of the wearer.

In some embodiments, the earphone body 1 further includes the housing 11. The housing 11 includes the first housing 11a and the second housing 11b assembled with the first housing 11a. When the earphone body 1 is worn on the ear 3, the first housing 11a is located between the ear 3 and the second housing 11b. The installation cavity 112 is arranged in the housing 11, and the installation cavity 112 is located between the first housing 11a and the second housing 11b. The housing 11 is provided with the installation hole 111, and the installation hole 111 is located in the first housing 11a. The installation cavity 112 is communicated with the outside through the installation hole 111. The audio guide hole 21 of the support frame 2 corresponds to the installation hole 111. More specifically, the support frame 2 surrounds the audio board 121 through the audio guide hole 21. The audio source 12 includes the audio board 121 and the speaker 122. The audio board 121 is installed inside the installation hole 111, that is, the support frame 2 surrounds the audio board 121 through the audio guide hole 21. Specifically, the audio board 121 is provided with a plurality of audio holes penetrating through the audio board 121, and the installation cavity 112 is communicated with the outside through the audio holes. The speaker 122 is installed inside the installation cavity 112, and the speaker 122 corresponds to the audio board 121. The sound emitted from the speaker 122 is transmitted to the outside of the installation cavity 112 through the audio board 121. When in use, the sound emitted from the speaker 122 is transmitted to the outside of the installation cavity 112 through the audio board 121 and to the ear canal 32 through the audio guide hole 21, thereby enabling the wearer to hear the sound emitted from the speaker 122.

In some embodiments, the housing 11 is provided with the buckle 113, that is, the first housing 11a is provided with the buckle 113. The buckle 113 is located on the outer side of the installation hole 111, and the support frame 2 is provided with the clamping slot 22 cooperating with the buckle 113. The support frame 2 is connected to the buckle 113 through the clamping slot 22 to realize that the support frame 2 is installed on the first housing 11a. Thus, the support frame 2 is installed on the housing 11, and further the support frame 2 is installed on the earphone body 1. The opening of the clamping slot 22 forms the extension part 23 cooperating with the clamping slot 22. When the support frame 2 is installed on the housing 11, the extension part 23 wraps the buckle 113 and abuts the housing 11.

The support frame 2 is made of soft and comfortable material. The soft and comfortable material can be one or more of the materials selected from thermoplastic polyurethane (TPU) elastomer rubber, thermoplastic elastomer (TPE), and silicon rubber.

In some embodiments, the earphone body 1 further includes a rechargeable battery, a printed circuit board, a flexible printed circuit (FPC) antenna, and a Bluetooth® module. Since the battery, the printed circuit board, the FPC antenna, and the Bluetooth® module are not related to the inventiveness of the present invention, they are not introduced here. Those skilled in the art can arrange the battery, the printed circuit board, the FPC antenna, and the Bluetooth® module according to the prior art.

The embodiments of the specific implementation modes are all preferred embodiments of the present invention and do not limit the scope of protection of the present invention. Hence, any equivalent change made according to the structure, shape, and principle of the present invention shall fall within the protection scope of the present invention.

What is claimed is:

1. An open-ear Bluetooth® earphone, comprising an earphone body, and a support frame, wherein the support frame is configured to be plugged into a cavum concha of a wearer, wherein the earphone body is provided with an audio source, and the support frame is installed on the earphone body and correspond to the audio source;
wherein when in use, the support frame is configured to be firmly plugged into the cavum concha of the wearer to allow the earphone body to be worn on an ear of the wearer; the audio source corresponds to an ear canal of the wearer through the support frame, so that a sound emitted from the audio source is transmitted into the ear canal through the support frame.

2. The open-ear Bluetooth® earphone according to claim 1, wherein an audio guide hole is formed in the support frame, the audio guide hole of the support frame tightly adheres to the audio source, and the audio guide hole is configured to transmit the sound emitted from the audio source into the ear canal.

3. The open-ear Bluetooth® earphone according to claim 2, wherein the earphone body comprises a housing, wherein an installation cavity is arranged in the housing, the housing is provided with an installation hole, and the installation cavity is communicated with an outside through the installation hole; the audio source comprises an audio board, wherein the audio board is installed inside the installation hole.

4. The open-ear Bluetooth® earphone according to claim 3, wherein the support frame tightly adheres to the housing, and the support frame surrounds the audio board through the audio guide hole.

5. The open-ear Bluetooth® earphone according to claim 3, wherein the housing is provided with a buckle, the buckle is located outside of the installation hole, the support frame is provided with a clamping slot cooperating with the buckle, and the support frame is connected to the buckle through the clamping slot.

6. The open-ear Bluetooth® earphone according to claim 5, wherein an opening of the clamping slot forms an extension part cooperating with the clamping slot, wherein when the support frame is installed on the housing, the extension part wraps the buckle and abuts the housing.

7. The open-ear Bluetooth® earphone according to claim 3, wherein the audio source further comprises a speaker, wherein the speaker is installed inside the installation cavity, the speaker corresponds to the audio board, and the sound emitted from the speaker is transmitted to an outside of the installation cavity through the audio board.

8. The open-ear Bluetooth® earphone according to claim 1, wherein the audio board is provided with a plurality of audio holes penetrating through the audio board.

9. The open-ear Bluetooth® earphone according to claim 1, wherein the support frame is made of soft and comfortable material.
